(19) United States
(12) Patent Application Publication
(10) Pub. No.: US 2019/0139113 A1
(43) Pub. Date: May 9, 2019

(54) ONLINE VEHICLE PURCHASING SYSTEM

(71) Applicant: Mogo IP Pty Ltd, Fullarton (AU)

(72) Inventors: Vanya Simeon ANDROPOV, Fullarton (AU); Gregory Desmond HARRIS, Fullarton (AU)

(73) Assignee: Mogo IP Pty Ltd

(21) Appl. No.: 16/175,378

(22) Filed: Oct. 30, 2018

(30) Foreign Application Priority Data
Nov. 3, 2017 (AU) 2017101560
Apr. 13, 2018 (AU) 2018901244

(51) Int. Cl. G06Q 30/06; G06Q 30/04; G06F 21/62

(52) U.S. Cl. CPC G06Q 30/0611; G06Q 30/04; H04L 67/02; G06F 21/6254; G06F 21/6263; G06Q 30/0635

(57) ABSTRACT

An online system that allows a buyer to find a car for sale and interact with a car dealer whilst remaining anonymous for as long as the buyer chooses. The buyer submits a request for a car quotation that is forwarded to matching car dealers. If a dealer provides a car quotation they incur a small charge. The quotation is forwarded to the buyer and an online chat channel is established between dealer and buyer. The buyer may chat with the dealer while remaining anonymous. If a quotation is not acceptable they buyer can end the chat and hear no more from the dealer. If a promising quotation is received the buyer may divulge their contact details and make further arrangements with the dealer such as a test drive or trade-in evaluation. Once the buyer has decided on a car the quotation request is completed.

### TECHNICAL FIELD

The present disclosure relates to an online system for purchasing vehicles. Whilst the present disclosure will be discussed in terms of cars, the disclosed system and method are suitable for use in advertising and selling all sorts of vehicles, including but not limited to cars, trailers, motorbikes, recreational vehicles, caravans, and boats.

### BACKGROUND

The first port of call for someone buying a vehicle, particularly a second hand car, is usually a classified advertisement. Such advertisements allow a buyer to peruse the market before initiating a transaction. Traditionally classified advertisements were found in newspapers or dedicated publications. With the advent of the Internet, a large proportion of classified advertisements have moved online. Whilst such online classified systems offer many advantages over traditional classified advertising such as easy searching and comparison of offerings, the buyer still needs to expend effort in searching effectively, trawling through the results and following promising advertisements for further details of potential car purchases.

Virtual monopolies have developed in the online classified industry, typically with the first effective provider in the industry gaining dominance. Late-comers are unable to offer dealers a large target audience, or buyers with a large selection of vehicles, leading both parties back to the largest provider, thus reinforcing the monopoly. The monopoly owners exploit their monopolies, charging large fees to car dealers, particularly commercial dealers. In some regions it is not uncommon for the monopoly owners to charge dealers for every online query that they get for a car. For example, a charge of around $50 may be made each time there is an online query relating to a vehicle. There is furthermore no possibility for the dealers to control the number of queries made and therefore no way for the dealers to control how much they are charged by the monopoly owners. It is quite easy for a dealer to incur $1,000 in online advertising fees on a single vehicle before managing to sell that vehicle.

In order to ensure that the fees are not bypassed, details of a particular dealer offering a car for sale are not given to a potential buyer until they make a query for which the dealer is charged. Quite often, a query made by a potential buyer may be simple, such as asking about a minor detail of the car or where the dealer is located. These types of queries little chance of leading to a sale but the dealer is still charged for these queries. In order for a buyer to be able to contact a dealer they must provide their contact details, and this contact information is given to the dealer in exchange for their fees. This often leads to harassment of the potential buyers as the dealers endeavour to get a return on the fees that they have paid. This may be very distressing for the buyers and has resulted in an environment that is considered a “necessary evil” for all parties involved.

### SUMMARY

The object of this disclosure is to provide an online car purchasing system to alleviate the above problems, or at least provide the public with a useful alternative to the prior art systems.

In a first aspect the disclosure comprises a system comprising a non-transitory memory; and one or more hardware processors coupled to the non-transitory memory and configured to read instructions from the non-transitory memory to cause the system to perform operations comprising presenting to a user in a web browser a form for producing a vehicle specification of a desired vehicle for quotation; receiving, in the web browser, a vehicle specification produced by the user; forwarding, in the web browser, the vehicle specification to a plurality of dealers; presenting to the plurality of dealers, in the web browser, the vehicle specification, and a form for producing a vehicle quotation; receiving, in the web browser, the vehicle quotation from a responding dealer of the plurality of dealers; presenting the vehicle quotation from the responding dealer to the user in the web browser.

The system performs further operations including establishing an Internet chat channel between the user and the responding dealer. The system performs further operations including presenting, on the web browser, a form for the user's personal details; and entering, on the web browser, the user's personal details into the user's personal details form. The system performs further operations including storing the user's personal details in the non-transitory memory. The system performs further operations including providing a filter in the non-transitory memory that separates a first name of the user and a zip code of the user from a remaining portion of the user's personal details. The system performs further operations including providing, to the plurality of dealers via the web browser, the first name, and the zip code of the user while hiding the remaining portion of the user's personal details. The providing of the first name and the zip code of the user is presented to the plurality of dealers on the web browser along with the vehicle specification. The system performs further operations including selecting, by the user on the web browser, a link to provide the remaining portion of the user's personal's details; retrieving the remaining portion of the user's personal details from the non-transitory memory; and providing the responding dealer with the remaining portion of the user's personal details.

In another aspect, the system further performs operations of presenting to the user, in the web browser, a form for producing a specification of a trade-in; receiving, in the web browser, a trade-in specification produced by the user; and forwarding, in the web browser, the trade-in specification to the plurality of dealers. The system further performs operations including forwarding from the responding dealer to the user, via the web browser, a trade-in amount based on the forwarded trade-in specification. The system further performs operations of presenting to the user, in the web browser, a form for specifying a geographical criterion on the plurality of dealers; and restricting the plurality of dealers to which the vehicle specification is forwarded based on the specified geographical criterion.

The system further performs operations including storing the vehicle specification forwarded to an individual dealer of the plurality of dealers to an archive in the non-transitory memory as an archived vehicle specification. The system further performs operations including retrieving one or more archived vehicle specifications from the archive in the non-transitory memory for the individual dealer; presenting, on the web browser, the one or more archived vehicle specifications to the individual dealer for review; and preparing, on the web browser, a vehicle quotation for the user based on the presented one or more archived vehicle specification. The system further performs operations including invoicing, on the web browser, the responding dealer in response to their producing of the vehicle quotation.

The system further performs operations including storing, in the non-transitory memory, personal details of the user; and preventing the plurality of dealers from accessing the stored personal details of the user in the non-transitory memory.

The system further performs operations including completing, on the web browser, the form for producing the vehicle specification by one of selecting and entering parameters of one or more of a vehicle manufacturer, a vehicle model, a vehicle body type, a vehicle fuel, a vehicle transmission type, a vehicle colour, and uploading one or more photographs; and storing the completed vehicle specification form in the non-transitory memory.

The system may further comprise one of selecting and entering, on the web browser, parameters relating to a new vehicle. The system may further comprise one of selecting and entering, on the web browser, parameters relating to a used vehicle. The web browser presents a user web page and a dealer web page; and the system performs further operations including presenting the user web page to a plurality of potential buyers; presenting the dealer web page to the plurality of dealers; maintaining the anonymity of each of the plurality of potential buyers; and providing to the responding dealer personal details of a specific potential buyer only after the specific potential buyer selects a contacts link on the user web page. The system performs further operations including closing the request for the vehicle quotation on the web browser after an occurrence of one of the following situations: receiving the vehicle quotation and rejecting the vehicle quotation; receiving the vehicle quotation and after one or more chat sessions on the Internet between the buyer and the responding dealer; and receiving the vehicle quotation, acceptance of the vehicle quotation and purchase of a vehicle that is a subject of the vehicle quotation.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the disclosure may be discerned from the following Detailed Description which provides sufficient information for those skilled in the art to perform the disclosure. The Detailed Description is not to be regarded as limiting the scope of the preceding Summary of the Disclosure in any way. The Detailed Description will make reference to a number of drawings as follows.

FIG. 1 is a flow chart of a buyer's interaction with an online advertising and purchasing system in accordance with an aspect of the present disclosure.

FIG. 2 is a flow chart of a dealer's interaction with the system.

FIG. 3 is a block diagram of an exemplary networked computer system to implement the system.

FIG. 4 is an exemplary screenshot of a Home web page of the system.

FIGS. 5A and 5B are an exemplary screenshot of a buyer's New Car Select web page of the system.

FIG. 6 is a selective exemplary screenshot of the buyer's Used Car Select web page of the system.

FIG. 7 is a selective exemplary screenshot of the buyer's Trade-in web page of the system.

FIG. 8 is an exemplary screenshot of the buyer's Dashboard web page of the system showing an active request.

FIG. 9 is an exemplary screenshot of the buyer's Dashboard web page of the system showing active quotes for a new car with a chat window open.

FIG. 10 is an exemplary screenshot of the buyer's Dashboard web page of the system showing an active chats.

FIG. 11 is an exemplary screenshot of the dealer's Dashboard web page of the system showing two new quotation requests.

FIG. 12 is an exemplary screenshot of a popup for the dealer to prepare a quotation for a vehicle.

FIG. 13 is an exemplary screenshot of a popup for the dealer to provide a price estimate for a trade-in.

FIG. 14 is an exemplary screenshot of an analytics page produced by the system in accordance with an aspect of the present disclosure.

### DETAILED DESCRIPTION OF THE DISCLOSURE

The following detailed description of an online system and method in accordance with an aspect of the disclosure refers to the accompanying drawings and will be referred to further herein as “the system”. Wherever possible, the same reference numbers will be used throughout the drawings and the following description to refer to the same and like parts. The system is described with the aid of various flow charts and extracts from web pages. The flow charts have been simplified to focus on major flows and features of the system, and illustrate just one of many possible interactions with the system. The website pages have been rearranged for static representational convenience with some well-known, repeated features and dialogs not shown.

The present disclosure provides an online system that allows a buyer to search and find a car for sale and to interact with a car dealer online whilst remaining anonymous for as long as the buyer chooses. In this description the terms “car”, “vehicle”, “automobile”, “trailer”, “motorbike”, “recreational vehicle”, “caravan”, and “boat” may be used interchangeably and should be understood to represent any type of vehicle that may be found and purchased utilizing the system and method as disclosed herein. Furthermore, the terms “dealer” and “car dealer” should be understood to be a merchant who offers for sale and sells the aforementioned “vehicle”. The terms “buyer” and “car buyer” should be understood to be a potential purchaser who is seeking to buy the “vehicle” from the “dealer”.

In accordance with an aspect of the present disclosure, the buyer uses the system to select a car and to submit a request for a car quotation. The request for the car quotation is forwarded by the system to a select group of car dealers, i.e., dealers who are offering vehicles that match the vehicle criteria as specified by the buyer. This select group of car dealers will be referred to herein as “matching car dealers”.

If, and only if, a matching car dealer chooses to provide the car quotation for the vehicle, then the matching car dealer will incur a small charge that is payable to the system. The car quotations prepared by the select group of matching car dealers are forwarded by the system to the buyer for review and action. An online chat channel may be established by the system between the matching car dealers who provided car quotations and the buyer. The buyer may chat with the matching dealers via the system or using other forms of contact, such as phone calls, texts, email, etc.; or the buyer may choose to stay anonymous.

A buyer may receive car quotations from multiple matching dealers. If a particular car quotation is not to the buyer's liking then the buyer can end the online chat with the specific matching dealer who provided the particular car quotation and hear no more from that specific matching dealer. The reason the buyer is unlikely to hear further from that specific matching dealer is because that this point in the transaction, the buyer has not divulged personal contact details to the specific matching dealer.

If, on the other hand, a promising car quotation is received through the system from one or more of the matching dealers, then the buyer may select to divulge their personal contact details to the matching dealers who provided those promising car quotations and the buyer may make further arrangements with one or more of the matching dealers. These further arrangements may include one or both of online activities and offline activities. These activities may include but are not limited to taking a test drive or having the matching dealer perform a trade-in evaluation of another vehicle that the buyer already owns. The trade-in evaluation may occur through the chat facility on the system or via conventional channels such as email, telephone, and in-person

The buyer may then select to purchase the particular vehicle on which the promising car quotation and subsequent activities were based. Once the buyer has decided on the particular car to purchase, the car quotation request on the system is completed.

This system may be advantageous to both the buyer and the dealer. The buyer may be provided, through the system, with car quotations that match their requirements. The buyer may choose which dealers they interact via the system and the buyer may choose when they interact with those dealers through the system. This aspect of the system helps to avoid unwanted harassment of the buyers by the dealers.

The dealers may also choose what car quotation requests on the system they wish to provide quotes for, thus controlling the expenses incurred. The system also may help reduce the dealers' workloads as the dealers only need to prepare car quotations and other materials on cars for which they have actual solid leads. In many instances, the dealers may only have to confirm that they have a particular car with the features desired by the buyer available and they may then decide on or confirm the price they wish to charge for that particular vehicle.

The system may also allow the buyer to include details of a trade-in vehicle in their car quotation request, saving them time and helping them to get a full picture as to what they will receive for their currently owned vehicle before they move further along the transaction path with matching dealers. This may be particularly beneficial where a buyer does not have the financial resources to own both vehicles simultaneously, or merely does not want the trouble of separately finding a buyer for their old vehicle.

The system in accordance with the present disclosure and the operation of the system can be appreciated with the aid of the attached figures.

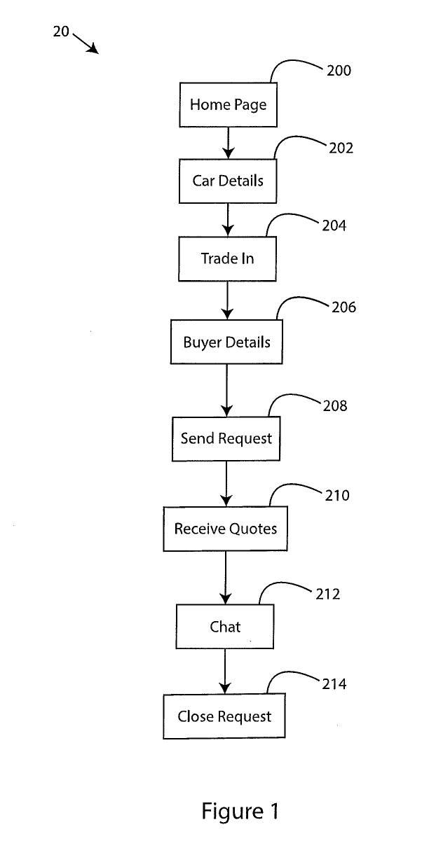

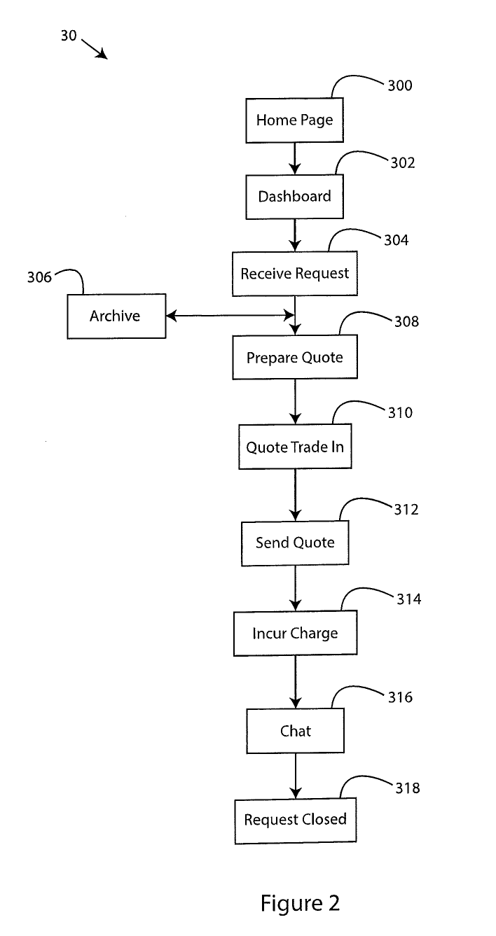

FIG. 1 is a flowchart which shows a buyer's interaction with the system. FIG. 2 is a flowchart showing a dealer's interaction with the system.

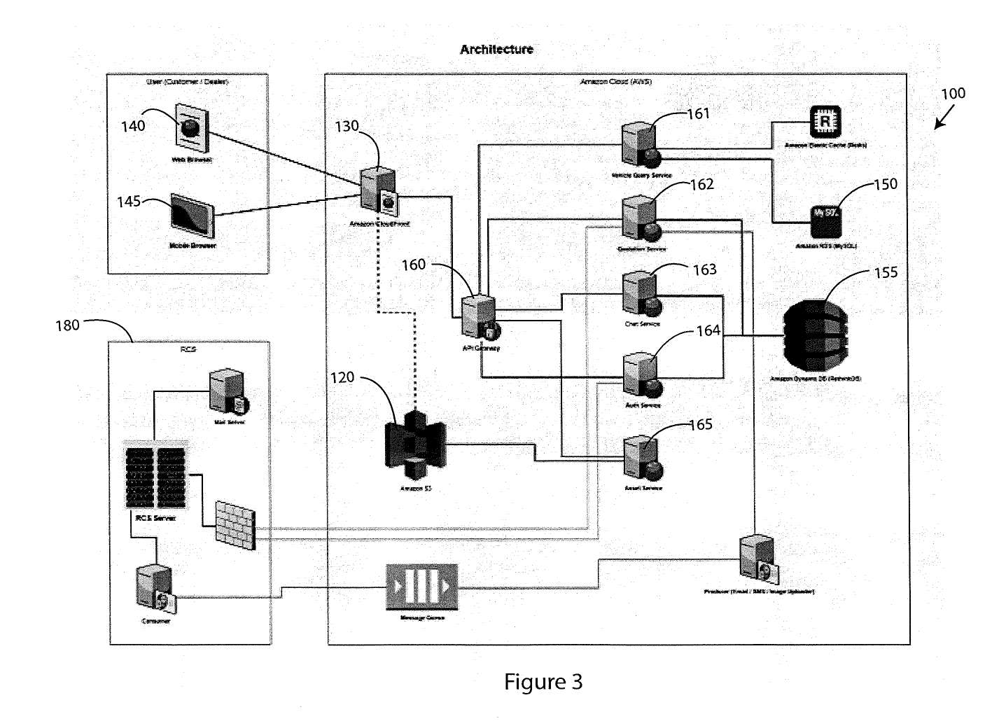

How to implement the system can appreciated with FIG. 3 which shows a block diagram of the system 100 implemented as an Internet-based computer system. System 100 may include a non-transitory memory; and one or more hardware processors physically and/or logically coupled to the non-transitory memory and configured to read instructions from the non-transitory memory to cause the system to perform a number of operations that will be described hereafter. The system as shown in FIG. 3 is discussed further below.

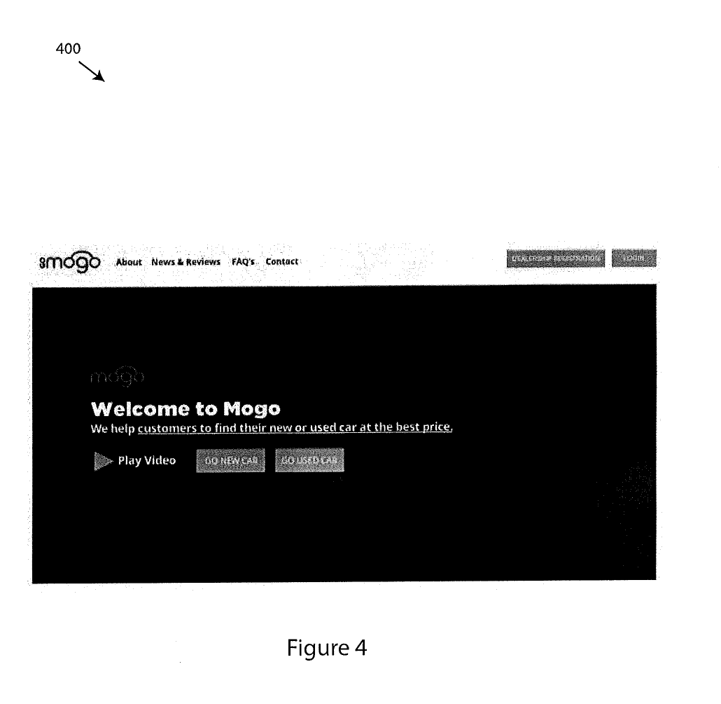

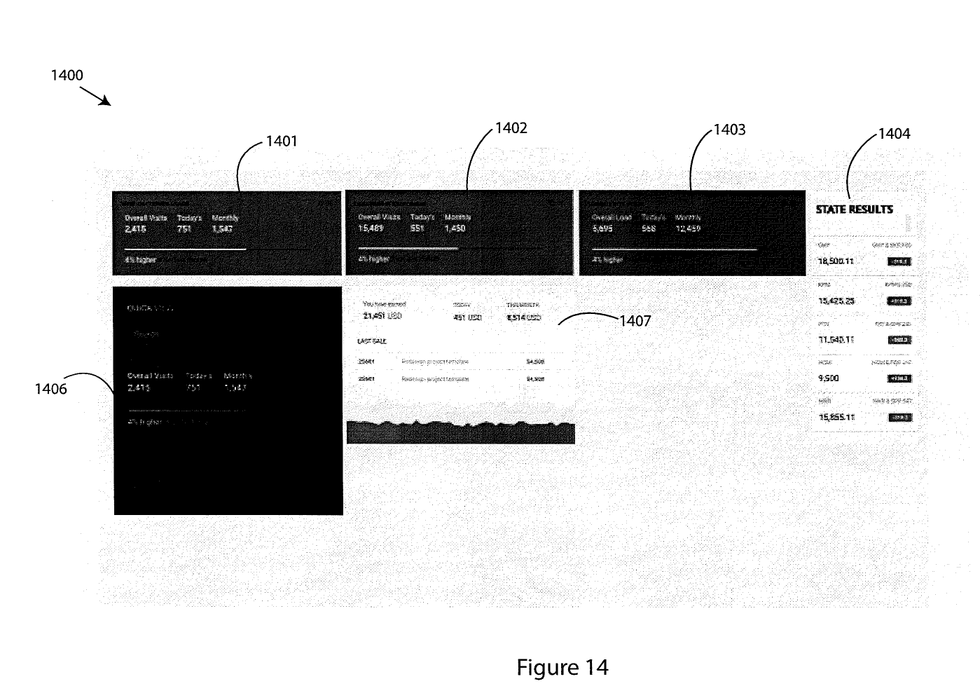

FIGS. 4 to 10 show various exemplary web pages of the system as seen by a buyer. FIGS. 4 and 11 to 13 show various exemplary web pages of the system as seen by a dealer. FIG. 14 shows some reporting features of the system.

The buyer flow chart shown as 20 in FIG. 1 starts at step 200 with a buyer connecting to a web browser on the Internet and visiting the system's home web page 400. An exemplary home web page for the system is shown in FIG. 4. Home web page 400 may provide the buyer with an informational video, links to other pages of the website such as News, About, FAQ, Reviews and Login, and links to help the buyer to start building a request for a car quotation for either a new car or a used car.

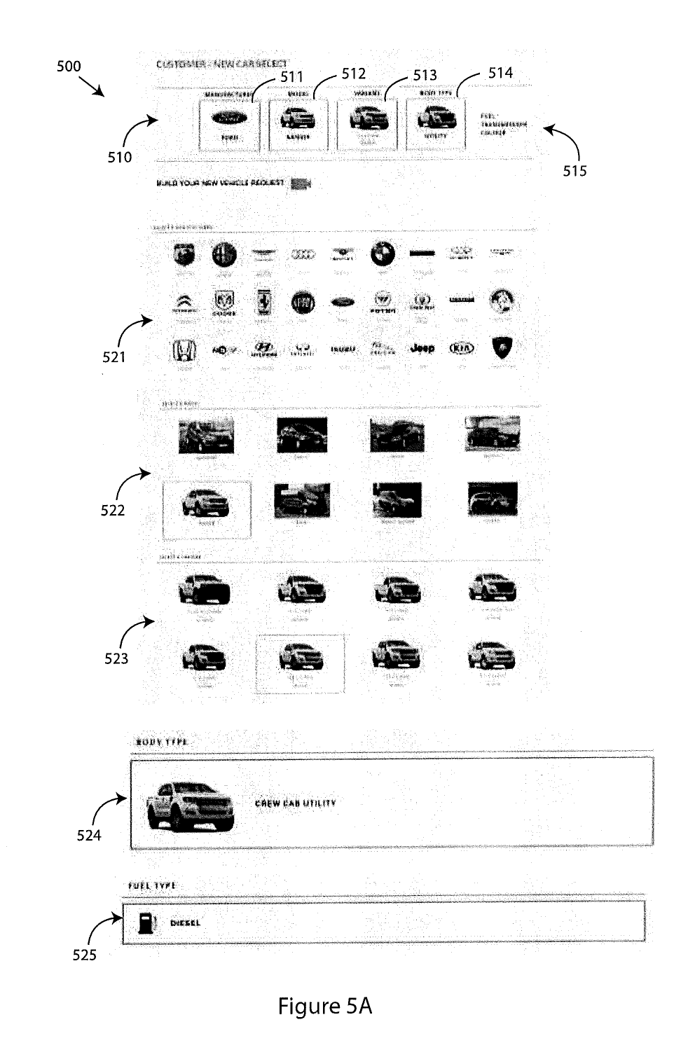

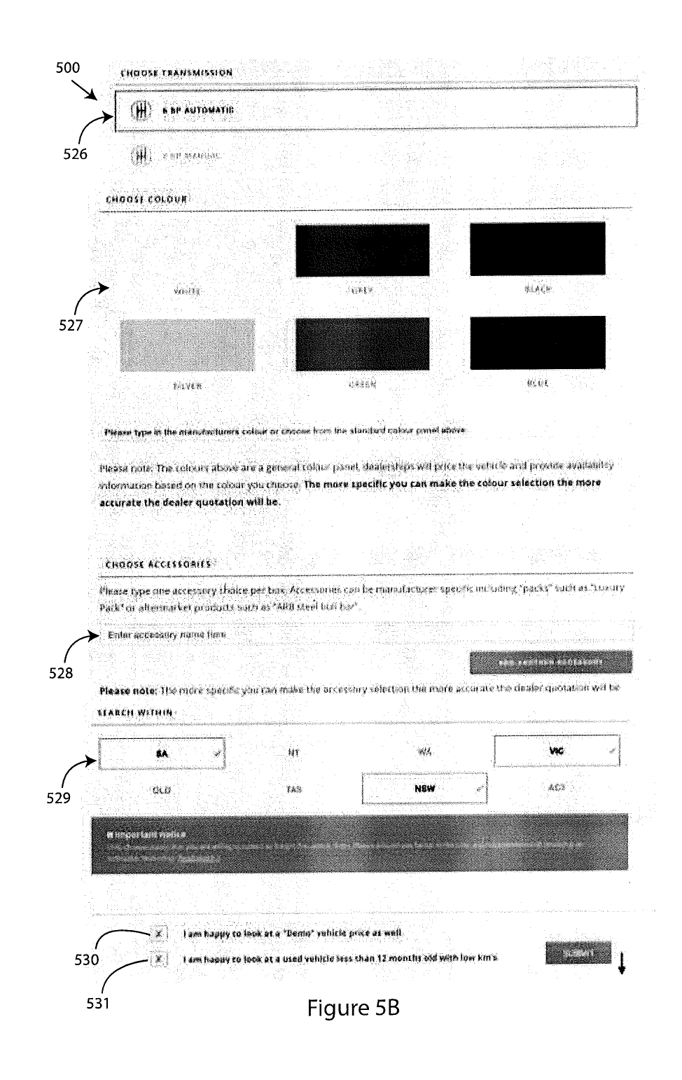

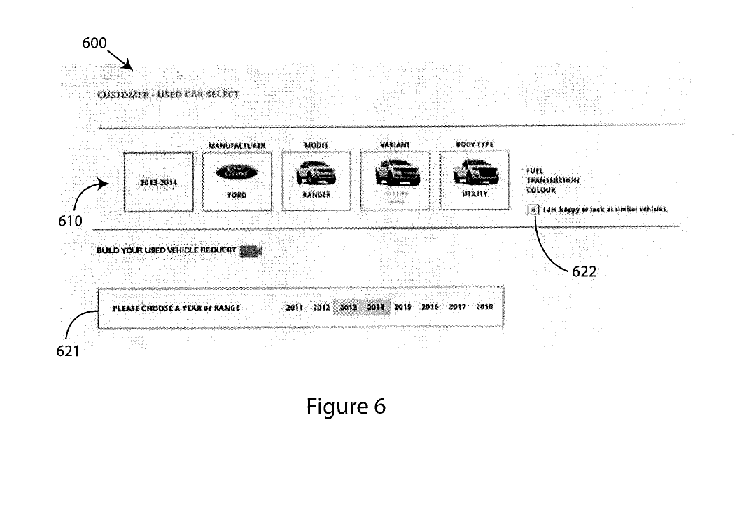

At step 202 the buyer, using the web browser, enters details relating to a new car or a used car for which the buyer wishes to receive a quotation. Step 202 includes an operation of presenting to a user, in the web browser, a form for producing a vehicle specification of a desired vehicle for quotation. The form is made available on the web browser by way of the New Car Select web page 500 shown in FIGS. 5A and 5B or by way of the Used Car Select web page 600 shown selectively in FIG. 6.

If the buyer wishes to purchase a new vehicle and opens the New Car Select web page, a heading strip 510 at the top of the page includes buttons 511, 512, 513, and 514 that may be used to reveal sections 521, 522, 523, and 524. Sections 521, 522, 523, and 524 may allow a buyer to select manufacturer, model, body type and variant of car. Photos are used to represent the various selections available and the buttons then populated with a photo corresponding to the selection chosen. Further elements on the page allow the selection of a vehicle fuel type 525, transmission 526 (FIG. 5B) and colour 527. Accessories may also be specified at 528. The geographical region 529 that the buyer is prepared to accept quotes from may also be selected. Options for demonstrator or low mileage cars are presented at 530 and 531.

Once the New Car Select web page 500 is open, the method of using the system includes the buyer completing, on the web browser, the form for producing the vehicle specification for a new vehicle by one of selecting and entering parameters of one or more of a vehicle manufacturer, a vehicle model, a vehicle body type, a vehicle fuel, a vehicle transmission type, a vehicle colour, uploading one or more photographs, selecting a geographical location etc. The method further includes storing the completed vehicle specification form in the non-transitory memory. After the buyer has completed the form provided by the New Car Select web page 500, at least some of the selections chosen by the buyer are summarised and displayed in the heading strip at 515 (FIG. 5A).

If the buyer wishes to receive a car quotation on a used vehicle, the buyer will select the Used Car Select web page 600 (FIG. 6) and will complete, on the web browser, the form that is presented to the buyer on the web page 600. The used Car Select web page 600 shares several features in common with the New Car Select web page 500 (FIGS. 5A and 5B) plus several features specific to selecting a used car, including a specific header strip 610 year range selector 621 and an option 622 to look at similar cars.

Once the Used Car Select web page 600 is open, the method of using the system includes the buyer completing, on the web browser, the form for producing the vehicle specification for a used vehicle by one of selecting and entering parameters of one or more of a vehicle manufacturer, a vehicle model, a vehicle body type, a vehicle fuel, a vehicle transmission type, a vehicle colour, uploading one or more photographs, selecting a geographical location etc. The method further includes storing the completed vehicle specification form in the non-transitory memory. After the buyer has completed the form provided by the Used Car Select web page 600, at least some of the selections chosen by the buyer may be summarised and displayed in the heading strip at 622 (FIG. 6).

Once the New Car Select web page 500 or the Used Car select web page 600 is completed, the buyer will submit the vehicle specification to the system 100 and request a car quotation. The vehicle specification and request for a car quotation is received by the system.

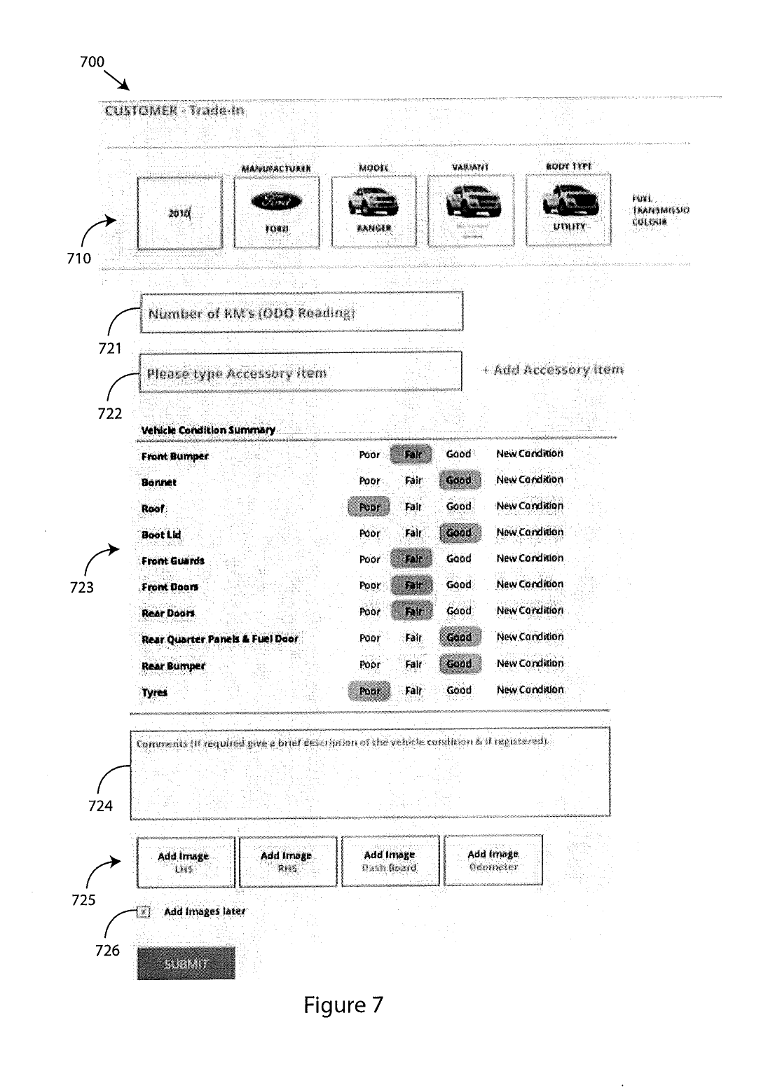

On submitting the New Car Select web page 500 or the Used Car Select web page 600 the buyer is prompted at optional step 204 (FIG. 1) to visit the Trade-in web page 700 (FIG. 7) in which the buyer can specify if they would like to receive a quote on a used car trade-in as part of their car purchasing deal. The buyer may enter the details of the used car that they wish to trade-in using the Trade-in web page 700. The Trade-in web page 700 shares several of the car detail entry features (not shown again) that are also shown on the New Car Select web page 500 (FIGS. 5A and 5B) such as the year, manufacturer, variant, colour etcetera. These details are shown in header strip 710 on the Trade-in web page 700. Various selectors specific to used car trade-ins can also be specified, such as odometer reading 721, accessories 722, car condition 723, and comments 724. The Trade-in web page 700 also permits one or more photographs 725 to be uploaded by the buyer straight away or the photographs may optionally be uploaded at a later time 726. Car registration details, beyond confirming that the car is currently registered, are not provided at this stage to safeguard the anonymity of the buyer. At step 206 (FIG. 1) the buyer's personal details are entered, if they have not registered with the system previously and are stored by the system in the non-transitory memory. The personal details that may be included are the buyer's name, email address, mobile phone number and postal code (zip code). The system may include any suitable type of filter or filtering software in the non-transitory memory that separates the user's first name and zip code from a remaining portion of the user's personal details. The car quotation request details, with only the buyer's first name and postal code (zip code), are then distributed at step 208 to matching dealers that may have an appropriate car. The remaining portion of the user's personal details are not included in the car quotation request. The plurality of dealers are also prevented from the stored personal details of the user in the non-transitory memory. The matching dealers are determined from a lookup of dealer details in the system database.

The buyer then waits to receive car quotes from matching dealers at step 210. At step 212 they buyer may then optionally choose to engage with the matching dealers who have provided car quotations via a chat facility at step 212. Finally, the request is closed at step 214 once the buyer is no longer looking for a car as per the request lodged. Typically this step 214 will be as a result of finalising a purchase or pursuing a fresh request for a different vehicle.

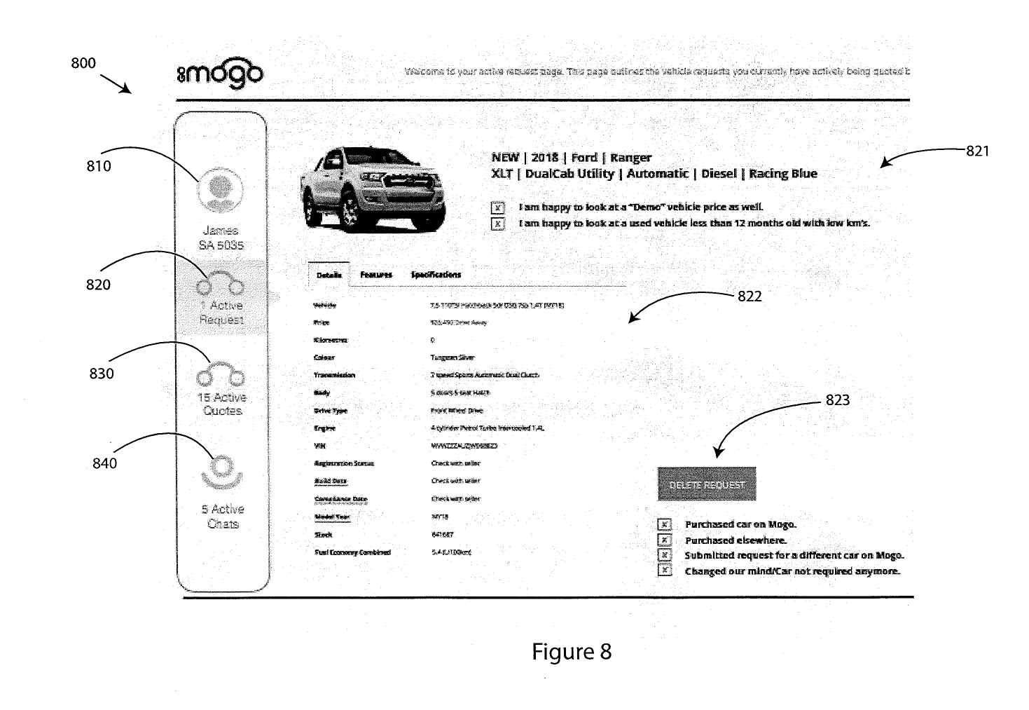

Once a car quotation request has been lodged a buyer interacts with the system via a buyer dashboard 800 as shown in FIG. 8. The dashboard includes navigation at the side that allows the buyer to access personal details 810, active requests 820, active quotes 830 and active chats 840. A returning user (i.e., a returning buyer) may login to the buyer dashboard 800 from the system's home page 400 (FIG. 4).

FIG. 8 shows the buyer dashboard 800 with an exemplary active request being displayed. The active request includes a summary of the car 821, details of the car 822 via tabbed panes and the ability to delete requests 823 with a reason why 824.

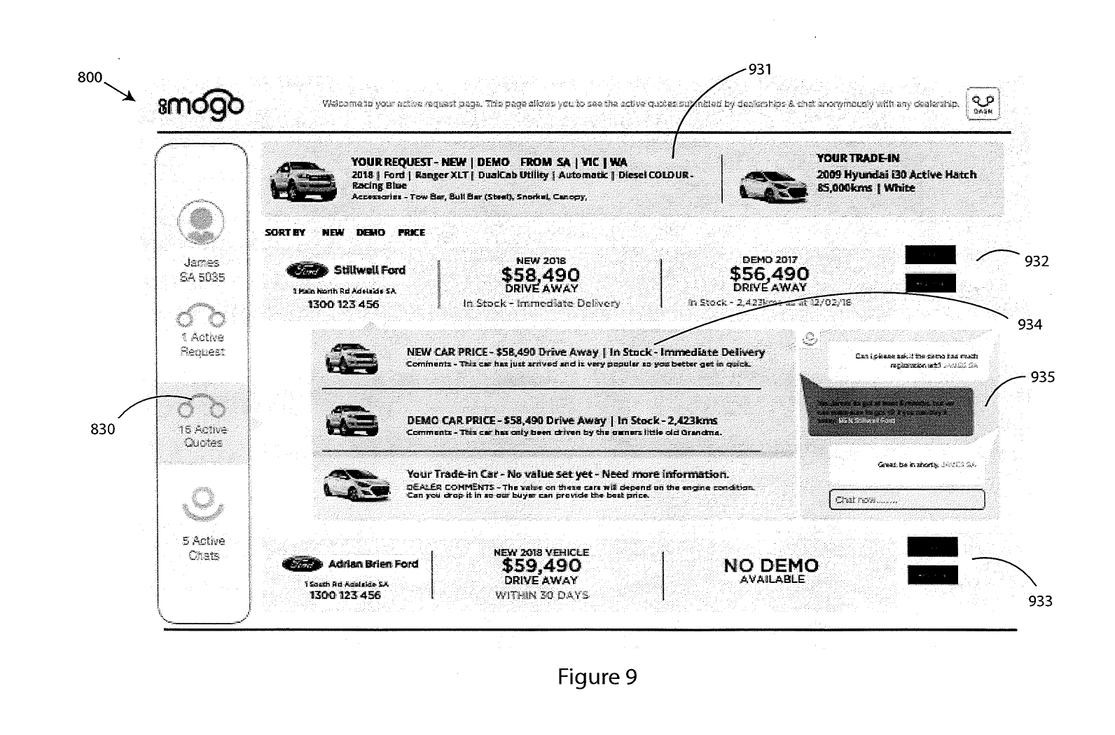

FIG. 9 shows the buyer dashboard 800 with the active quotes button 830 highlighted. The buyer dashboard 800 has exemplary active quotes 932 and 933 being displayed. The top of the buyer dashboard displays a request summary 931 with basic details of the requested car and trade-in details. In this case a new car has been requested. Each active quote shows dealer details and a quoted price at which the car is being offered by the dealer. In the case of a new car, an offer for a demo vehicle may also be present if requested. The quote may be expanded, as at 932 to show further details 934 of the new car, the demo car and the trade-in offer, i.e., the amount that is offered for the trade-in. A chat window 935 is also presented which allows the buyer to chat anonymously with the dealer who has provided the car quotation that is displayed.

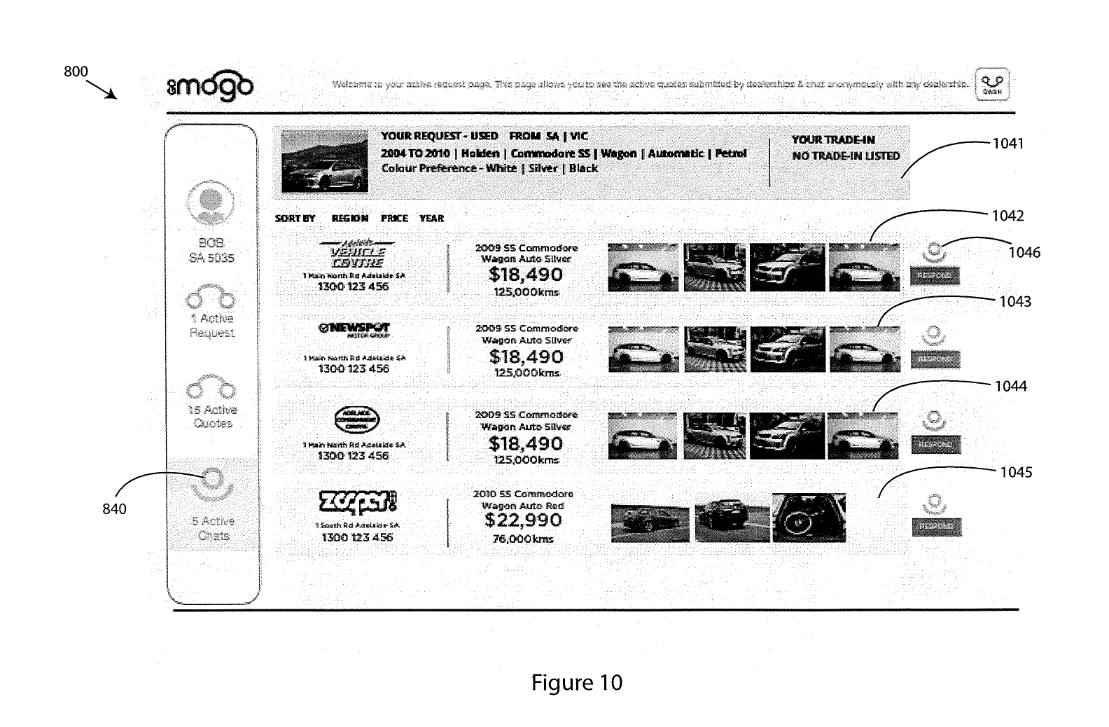

FIG. 10 shows the buyer dashboard 800 with the active chats button 840 highlighted and having exemplary active chats displayed. In particular, the buyer dashboard 800 shows an active chat relating to a used car request. A request summary 1041 includes brief details of the requested car and any trade-in. Summaries of corresponding quotes 1042, 1043, 1044, and 1045 are shown. These summaries 1042-1045 include dealer details and a summary of the used car being offered by the dealer along with photos. A chat icon 1046 indicates if there is a chat message available from the dealer that can be opened up and be engaged with.

The dealer flow chart shown as 30 in FIG. 2 starts at step 300 with the dealer visiting the Home web page 400 (FIG. 4) of the system web site. A new dealer can follow a link to register their details, a returning dealer who has already entered their details will instead login and proceed to a dealer dashboard.

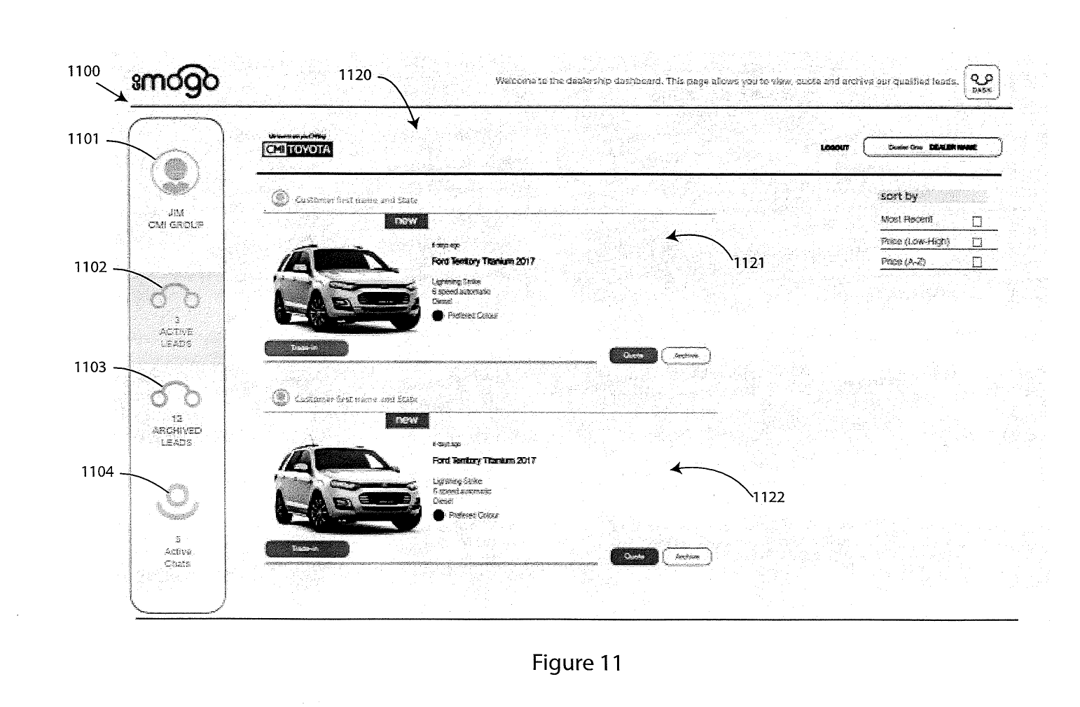

At step 302 (FIG. 2) the dealer visits the Dealer Dashboard web page 1100 that is shown in FIG. 11. The Dealer Dashboard web page 1100 includes navigation giving access to the dealer's registration details 1101, active leads 1102, archived leads 1103 and active chats 1104. FIG. 11 shows an exemplary active leads section 1120 which is showing two new lead requests 1121 and 1122. At step 304 (FIG. 2), the dealer receives a request to prepare a car quotation for a vehicle that matches the vehicle that the buyer is seeking. The dealer has the option of archiving that lead at step 306 (FIG. 2) or of preparing a car quotation on the lead at step 308 (FIG. 2). A dealer would most likely archive a request 306 if they had no suitable matching vehicle on which to prepare the car quotation. The request remains archived 306 until the car quotation request is either closed by the buyer or is retrieved from the archive by the dealer so that the dealer can proceed with a car quotation as per step 308.

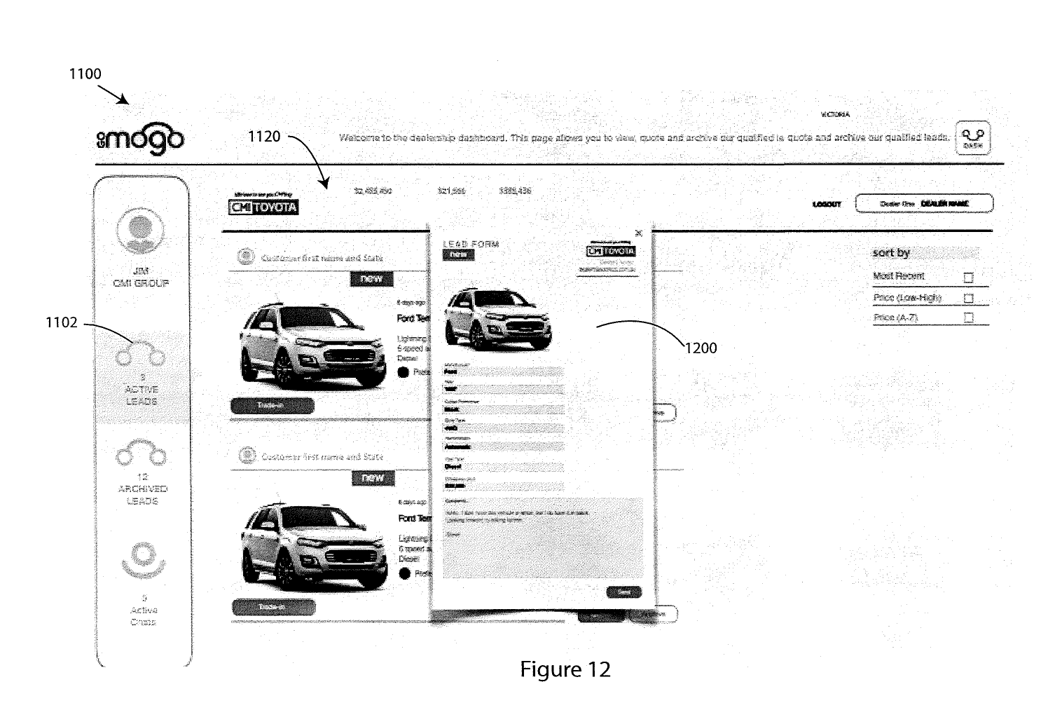

At step 308 the dealer opens the request to prepare a quote. In FIG. 12 this is step is shown in a popup window 1200 from the active leads section 1102 of the Dealer Dashboard 1100 for a new car. The popup window 1200 may also be launched from the archived leads section 1103 (FIG. 11) of the Dealer Dashboard 1100. The dealer fills in the price details and comments as appropriate, e.g. offering an alternative colour to that requested by the buyer in their request for a car quotation.

The process for quoting a used car is similar to the steps relating to a new car described above. In the instance of quoting for a used car, the dealer will open up a slightly different but similar pop-up (not shown) from the pop-up 1200 shown in FIG. 12, in order to enter appropriate vehicle details and photos.

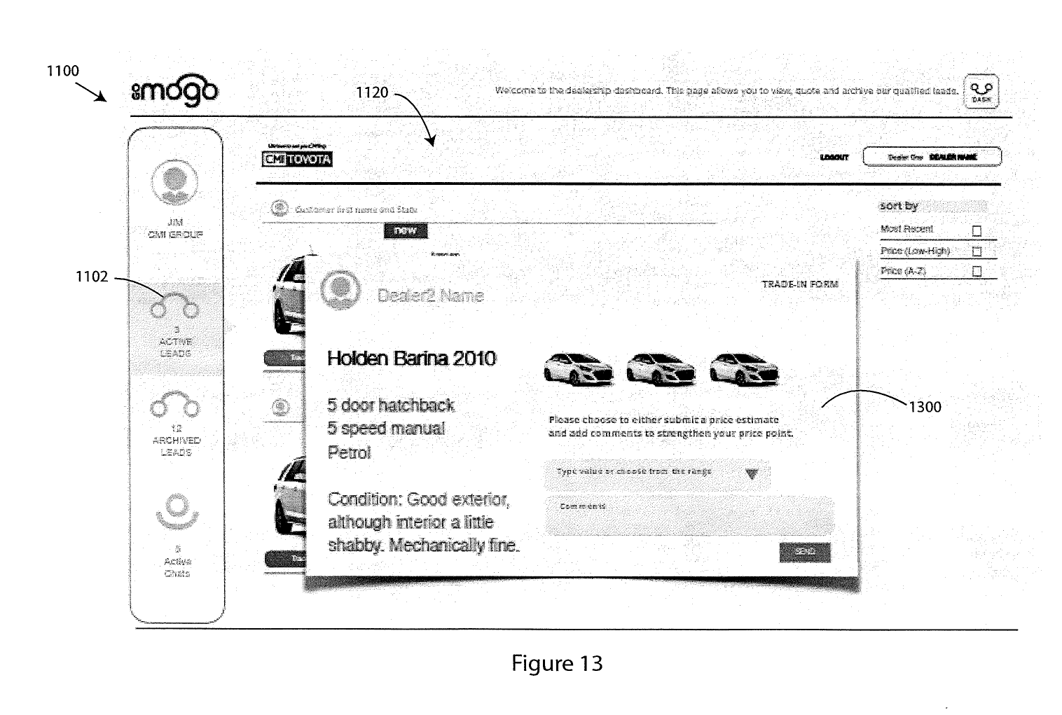

As part of the car quotation the dealer may also submit an offer for a trade-in 310 (FIG. 2) if this has been requested by the buyer. In order to submit the offer for a trade-in 310 the dealer will open up the popup shown in FIG. 13 as 1300 on the Dealer Dashboard 1100. Step 312 (FIG. 2) is that the dealer completes and sends out the car quotation on the system and then incurs a charge at step 314.

Once the car quotation has been submitted in step 312, the dealer waits for the buyer to commence a chat session at step 316 (FIG. 2). Active chats may be accessed via the active chats icon 1104 (FIG. 11) on the Dealer Dashboard 1100. A chat between the buyer and dealer will continue until the chat is closed by the buyer at step 318 (FIG. 2). It is up to the dealer and the buyer as to what is discussed in the chat session, with the buyer remaining anonymous until they choose otherwise.

The above process allows the buyer to easily engage with a number of different dealers and receive competing offers without the buyer needing to identify themselves. The dealers in turn can engage with many potential buyers with little cost or effort.

The system could be implemented using a variety of underlying technologies. A block diagram of a possible system architecture is shown as 100 in FIG. 3 implementing a cloud based solution using AWS (Amazon Web Services) 110 offered by AMAZON® to readily handle growth of system usage. AMAZON® S3 120 provides storage of static content, such as image and code libraries. AMAZON® CloudFront 130 helps speed content delivery by locally caching where possible. Buyers and dealers interact with the system through either a web application 140, or a mobile application 145, that have been developed using Vue.js for the front end, and Node.js for the back end. PhoneGap offered by ADOBE® or equivalent programs may be used to generate the mobile application. The system includes a MySQL database 150 for storing vehicle information to help produce car quotation requests and a ReThink database 155 for storing user data such as quotes, responses, user details and chat sessions. An API (Application Programming Interface) gateway 160 provides a single access point to a series of services including: a vehicle query service 161 that allows users to define a vehicle; a quotation service 162 that handles quotation requests from users and distributes them to appropriate dealers, as well as storing and retrieving quotations from the database 155; a chat service 163 that allows a buyer to chat anonymously with a dealer; an authentication service 164 to administer and authenticate dealer and buyer logins and sessions, including forwarding authentication requests to third party applications; and, an asset service 165 to manage the upload of images from users and dealers, and serving static web content. Billing is handled by a third party billing server 180 which is not part of the system.

The system also incorporates administrative reporting functions able to produce a display such as at 1400 shown in FIG. 14 with various metrics including: new customer leads 1401, dealer responses 1402, unique site visits 1403 and revenue generated 1405. These results may be combined in an overview 1406 or broken down by region 1407.

The reader will now appreciate the present disclosure which provides an online system that allows a buyer to find a car for sale and interact with a car dealer whilst remaining anonymous for as long as they choose.

In summary, the system comprises a non-transitory memory; and one or more hardware processors coupled to the non-transitory memory and configured to read instructions from the non-transitory memory to cause the system to perform operations comprising presenting to a user in a web browser a form for producing a vehicle specification of a desired vehicle for quotation; receiving, in the web browser, a vehicle specification produced by the user; forwarding, in the web browser, the vehicle specification to a plurality of dealers; presenting to the plurality of dealers, in the web browser, the vehicle specification, and a form for producing a vehicle quotation; receiving, in the web browser, the vehicle quotation from a responding dealer of the plurality of dealers; presenting the vehicle quotation from the responding dealer to the user in the web browser.

The system performs further operations including establishing an Internet chat channel between the user and the responding dealer. The system performs further operations including presenting, on the web browser, a form for the user's personal details; and entering, on the web browser, the user's personal details into the user's personal details form. The system performs further operations including storing the user's personal details in the non-transitory memory. The system performs further operations including providing a filter in the non-transitory memory that separates a first name of the user and a zip code of the user from a remaining portion of the user's personal details. The system performs further operations including providing, to the plurality of dealers via the web browser, the first name, and the zip code of the user while hiding the remaining portion of the user's personal details. The providing of the first name and the zip code of the user is presented to the plurality of dealers on the web browser along with the vehicle specification. The system performs further operations including selecting, by the user on the web browser, a link to provide the remaining portion of the user's personal's details; retrieving the remaining portion of the user's personal details from the non-transitory memory; and providing the responding dealer with the remaining portion of the user's personal details.

In another aspect, the system further performs operations of presenting to the user, in the web browser, a form for producing a specification of a trade-in; receiving, in the web browser, a trade-in specification produced by the user; and forwarding, in the web browser, the trade-in specification to the plurality of dealers. The system further performs operations including forwarding from the responding dealer to the user, via the web browser, a trade-in amount based on the forwarded trade-in specification. The system further performs operations of presenting to the user, in the web browser, a form for specifying a geographical criterion on the plurality of dealers; and restricting the plurality of dealers to which the vehicle specification is forwarded based on the specified geographical criterion.

The system further performs operations including storing the vehicle specification forwarded to an individual dealer of the plurality of dealers to an archive in the non-transitory memory as an archived vehicle specification. The system further performs operations including retrieving one or more archived vehicle specifications from the archive in the non-transitory memory for the individual dealer; presenting, on the web browser, the one or more archived vehicle specifications to the individual dealer for review; and preparing, on the web browser, a vehicle quotation for the user based on the presented one or more archived vehicle specification. The system further performs operations including invoicing, on the web browser, the responding dealer in response to their producing of the vehicle quotation.

The system further performs operations including storing, in the non-transitory memory, personal details of the user; and preventing the plurality of dealers from accessing the stored personal details of the user in the non-transitory memory.

The system further performs operations including completing, on the web browser, the form for producing the vehicle specification by one of selecting and entering parameters of one or more of a vehicle manufacturer, a vehicle model, a vehicle body type, a vehicle fuel, a vehicle transmission type, a vehicle colour, and uploading one or more photographs; and storing the completed vehicle specification form in the non-transitory memory.

The system may further comprise one of selecting and entering, on the web browser, parameters relating to a new vehicle. The system may further comprise one of selecting and entering, on the web browser, parameters relating to a used vehicle. The web browser presents a user web page and a dealer web page; and the system performs further operations including presenting the user web page to a plurality of potential buyers; presenting the dealer web page to the plurality of dealers; maintaining the anonymity of each of the plurality of potential buyers; and providing to the responding dealer personal details of a specific potential buyer only after the specific potential buyer selects a contacts link on the user web page. The system performs further operations including closing the request for the vehicle quotation on the web browser after an occurrence of one of the following situations: receiving the vehicle quotation and rejecting the vehicle quotation; receiving the vehicle quotation and after one or more chat sessions on the Internet between the buyer and the responding dealer; and receiving the vehicle quotation, acceptance of the vehicle quotation and purchase of a vehicle that is a subject of the vehicle quotation.

Further advantages and improvements may very well be made to the present disclosure without deviating from its scope. Although the disclosure has been shown and described in what is conceived to be the most practical and preferred embodiment, it is recognized that departures may be made therefrom within the scope of the present disclosure, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or Internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A system comprising:
a non-transitory memory; and
one or more hardware processors coupled to the non-transitory memory and configured to read instructions from the non-transitory memory to cause the system to perform operations comprising:
presenting to a user in a web browser a form for producing a vehicle specification of a desired vehicle for quotation;
receiving, in the web browser, a vehicle specification produced by the user;
forwarding, in the web browser, the vehicle specification to a plurality of dealers;
presenting to the plurality of dealers, in the web browser, the vehicle specification, and a form for producing a vehicle quotation;
receiving, in the web browser, the vehicle quotation from a responding dealer of the plurality of dealers; and
presenting the vehicle quotation from the responding dealer to the user in the web browser.

2. The system as in claim 1, wherein the system performs further operations including:
establishing an Internet chat channel between the user and the responding dealer.

3. The system as in claim 1, wherein the system performs further operations including:
presenting, on the web browser, a form for the user's personal details; and
entering, on the web browser, the user's personal details into the user's personal details form.

4. The system as in claim 3, wherein the system performs further operations including:
storing the user's personal details in the non-transitory memory.

5. The system as in claim 4, wherein the system performs further operations including:
providing a filter in the non-transitory memory that separates a first name of the user and a zip code of the user from a remaining portion of the user's personal details.

6. The system as in claim 5, wherein the system performs further operations including:
providing, to the plurality of dealers via the web browser, the first name, and the zip code of the user while hiding the remaining portion of the user's personal details.

7. The system as in claim 6, wherein the providing of the first name and the zip code of the user is presented to the plurality of dealers on the web browser along with the vehicle specification.

8. The system as in claim 6, wherein the system performs further operations including:
selecting, by the user on the web browser, a link to provide the remaining portion of the user's personal's details;
retrieving the remaining portion of the user's personal details from the non-transitory memory; and
providing the responding dealer with the remaining portion of the user's personal details.

9. The system as in claim 1, wherein the system further performs operations of:
presenting to the user, in the web browser, a form for producing a specification of a trade-in;
receiving, in the web browser, a trade-in specification produced by the user; and
forwarding, in the web browser, the trade-in specification to the plurality of dealers.

10. The system as in claim 9, wherein the system further performs operations including:
forwarding from the responding dealer to the user, via the web browser, a trade-in amount based on the forwarded trade-in specification.

11. The system as in claim 1, wherein the system further performs operations of:
presenting to the user, in the web browser, a form for specifying a geographical criterion on the plurality of dealers; and
restricting the plurality of dealers to which the vehicle specification is forwarded based on the specified geographical criterion.

12. The system as in claim 1, wherein the system further performs operations including:
storing the vehicle specification forwarded to an individual dealer of the plurality of dealers to an archive in the non-transitory memory as an archived vehicle specification.

13. The system as in claim 12, wherein the system further performs operations including:
retrieving one or more archived vehicle specifications from the archive in the non-transitory memory for the individual dealer;
presenting, on the web browser, the one or more archived vehicle specifications to the individual dealer for review; and
preparing, on the web browser, a vehicle quotation for the user based on the presented one or more archived vehicle specification.

14. The system as in claim 1, wherein the system further performs operations including:
invoicing, on the web browser, the responding dealer in response to their producing of the vehicle quotation.

15. The system as in claim 1, wherein the system further performs operations including:
storing, in the non-transitory memory, personal details of the user; and
preventing the plurality of dealers from accessing the stored personal details of the user in the non-transitory memory.

16. The system as in claim 1, wherein the system further performs operations including:
completing, on the web browser, the form for producing the vehicle specification by one of selecting and entering parameters of one or more of a vehicle manufacturer, a vehicle model, a vehicle body type, a vehicle fuel, a vehicle transmission type, a vehicle colour, and uploading one or more photographs; and
storing the completed vehicle specification form in the non-transitory memory.

17. The system as in claim 16, further comprising:
one of selecting and entering, on the web browser, parameters relating to a new vehicle.

18. The system as in claim 16, further comprising:
one of selecting and entering, on the web browser, parameters relating to a used vehicle.

19. The system as in claim 1, wherein the web browser presents a user web page and a dealer web page; and the system performs further operations including:
presenting the user web page to a plurality of potential buyers;
presenting the dealer web page to the plurality of dealers;
maintaining the anonymity of each of the plurality of potential buyers; and
providing to the responding dealer personal details of a specific potential buyer only after the specific potential buyer selects a contacts link on the user web page.

20. The system as in claim 1, wherein the system performs further operations including:
closing the request for the vehicle quotation on the web browser after an occurrence of one of the following situations:
receiving the vehicle quotation and rejecting the vehicle quotation;
receiving the vehicle quotation and after one or more chat sessions on the Internet between the buyer and the responding dealer; and
receiving the vehicle quotation, acceptance of the vehicle quotation and purchase of a vehicle that is a subject of the vehicle quotation.
